(19) United States
(12) Patent Application Publication
(10) Pub. No.: US 2017/0190116 A1
(43) Pub. Date: Jul. 6, 2017

(54) EXTRUDER FOR A 3D PRINTER

(71) Applicant: 3D FAB LAB LTD., Chai Wan (HK)

(72) Inventors: Robert Grosche, Dasmasrians City (PH); Thomas Chow, Dasmarinas City (PH); Karl Nofuente, Dasmarinas City (PH)

(21) Appl. No.: 15/208,048

(22) Filed: Jul. 12, 2016

(30) Foreign Application Priority Data
Dec. 16, 2015 (PH) 12015000435

(51) Int. Cl. B29C 67/00; B33Y 30/00

(52) U.S. Cl. CPC B29C 67/0085; B33Y 30/00; B29K 2827/18

(57) ABSTRACT

Embodiments disclosed herein relate to an extruder for a 3D printer. The extruder for a 3D printer includes a finned head, a lower tube being accommodated at the lower portion of the finned head, a heating base accommodating a lower portion of the lower tube, and a dispensing nozzle being fitted at a coinciding hole at the heating base. The lower tube is characterized by an externally threaded opposing ends and a plain tube being made thinner in wall thickness and said plain portion made longer, and a polytetrafluorethylene (PTFE) material coating the internal wall of the lower tube.

### CROSS-REFERENCE TO RELATED APPLICATION

This application claims the benefit of Phillippines Patent Application No. 12015000435, filed Dec. 16, 2015, the entire disclosure of which is incorporated here by reference.

### TECHNICAL FIELD

This invention generally relates to additive manufacturing or 3D printing technology in product making but more particularly to an extruder for a 3D printer.

### BACKGROUND

One of the models for a 3D printer utilizes an extruder for a fused deposition of a heated thermoplastic filament to thereby form an object being predetermined to be formed or fabricated. In actual operation of current extruders for 3D printer, periodic stoppage are experienced because of jamming therein, thereby causing a failure to accomplish the ideal completion time for an object to be produced.

### SUMMARY OF THE INVENTION

In view of the foregoing, it is one object of this invention to provide an extruder for a 3D printer that would continuously operate or function without the problematic jamming to thereby ensure a production output according to the predetermined ideal time.

Another object of this invention is to provide an extruder for a 3D printer that is simple in construction yet very functionally reliable. The present invention which is a product of extensive research and development has been actually proven to solve the aforementioned problem indicated in the background of the invention.

Other objects and advantages of the present invention for an extruder for a 3D printer will be fully understood and readily appreciated after reading the following detailed description made in conjunction with the accompanying drawings thereof.

### BRIEF DESCRIPTIONS OF THE DRAWINGS

FIG. 1 is a perspective view of an extruder for a 3D printer.

FIG. 2 is a side elevation view of the extruder shown in FIG. 1.

FIG. 3 is a longitudinal sectional view of the extruder.

FIG. 4 is an exploded view of the same extruder.

FIG. 5 is an enlarged fragmentary view taken at the lower portion of FIG. 3.

FIG. 6 is a perspective view of a lower tube of the extruder.

FIG. 7 is a longitudinal sectional view of the lower tube shown in FIG. 6.

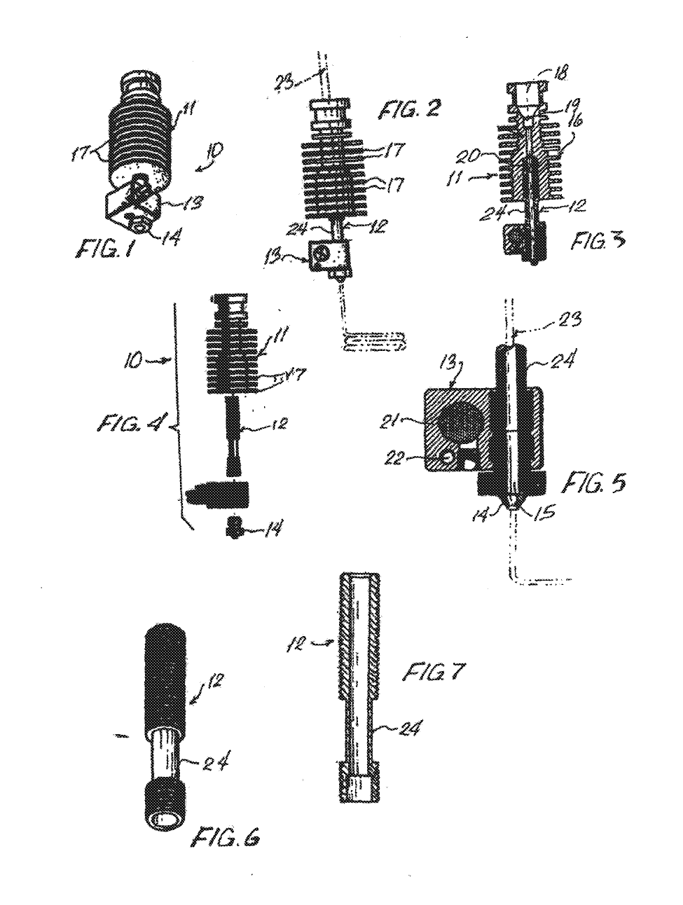

### DETAILED DESCRIPTION

Referring now to the drawings, there is shown the extruder 10 generally comprising a finned head 11, a lower tube 12 being accommodated at the lower portion of the finned head 11, a heating base 13 accommodating the lower portion of the lower tube 12, and a dispensing nozzle 14 being fitted at a coinciding hole 15 of the heating base 13.

As shown in FIG. 3, the finned head 11 is defined by a stepped cylindrical body 16 having a plurality of spacedly provided cooling fins 17 being provided along its length. The stepped cylindrical body 16 has a wide mouth 18 which converges into its narrower hole 19 and an internally threaded lower hole 20.

As shown in FIG. 5, the lower portion of the extruder 10 is fitted with a heating base 13 which comprises a heater 21 and a thermistor 22. The heater 21 will provide the required heat to soften a thermoplastic filament 23 (in broken lines) being introduced in the extruder 10.

The improvement being featured by the present invention resides in the lower tube 12 having externally threaded opposing ends and a plain portion 24 between the threaded ends. The outstanding improvement which solve the afore-stated problem of jamming is characterized by said lower tube 12 being made thinner by around a half of a millimeter (0.5 mm.) in wall thickness while the plain portion 24 made longer for better heat dissipation. Forming part of the improvement is the coating with polytetrafluoroethylene (PTFE) material, or its equivalent, of the internal surface or wall of the lower tube 12. PTFE material which is popularly known by its trademark, “TEFLON,” s best considered because of its lower coefficient of friction, thereby insuring unimpeded flow of the heat-softened plastic to consequently prevent jamming.

While the invention has been disclosed in connection with the preferred embodiment described in detail with the appended drawings, various modifications, innovations, or improvements thereon will become readily apparent to those skilled in the art. Accordingly, the spirit and scope of the present invention is not limited by the foregoing embodiment but is to be understood in the broadest sense allowable by law.

What is claimed is:

1. An extruder for a 3D printer, comprising: a finned head, a lower tube being accommodated at the lower portion of the finned head, a heating base accommodating a lower portion of the lower tube, and a dispensing nozzle being fitted at a coinciding hole at the heating base, said lower tube being characterized by an externally threaded opposing ends and a plain tube being made thinner in wall thickness and said plain portion made longer, and a polytetrafluorethylene (PTFE) material coating the internal wall of the lower tube.
